(19) United States
(12) Patent Application Publication
(10) Pub. No.: US 2007/0232228 A1
(43) Pub. Date: Oct. 4, 2007

(54) Wireless repeater with universal server base unit and modular donor antenna options

(76) Inventors: David L. McKay SR., Duluth, GA (US); Donald L. Runyon, Duluth, GA (US); Stephen Brett Thompson, Norcross, GA (US); James William Maxwell, Atlanta, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 11/397,304

(22) Filed: Apr. 4, 2006

(51) Int. Cl. H04B 7/15

(52) U.S. Cl. 455/11.1

(57) ABSTRACT

A wireless repeater that includes a universal server base unit and modular donor antenna options. The universal server base unit includes a base unit bidirectional amplifier, a server antenna, and a housing that accepts an internal donor antenna board or an internal adapter module connected to a cable port for receiving a coaxial cable connected to an external donor antenna. This allows the same universal server base unit to work with a variety of internal and external donor antenna options. In particular, the external donor antennas include outdoor swivel-mounted options including a helical circular polarization antenna, a dual polarization panel antenna, and a vertical polarization panel antenna. The donor antenna may include an optional donor bidirectional antenna located in or near the donor antenna and powered via the cable from the server base unit.

### REFERENCE TO RELATED APPLICATIONS

This application incorporates by reference commonly-owned copending U.S. patent application Ser. No. 10/375,879 entitled “Cellular Signal Enhancer” filed Feb. 26, 2003; U.S. patent application Ser. No. 11/127,668 entitled “Mounting Pedestal for a Cellular Signal Enhancer” filed May 13, 2005; and U.S. patent application Ser. No. 11/372,856 entitled “Dual Polarization Wireless Repeater Including Antenna Elements with Balanced and Quasi-Balanced Feeds” filed Mar. 11, 2006.

### TECHNICAL FIELD

The present invention relates generally to wireless repeaters, which are also known as cellular signal enhancers. More particularly, the invention relates to a wireless repeater that includes a universal server base unit and modular donor antenna options that allows the user to select among a variety of donor antennas including internal donor antenna options mounted within the universal server base unit and external donor antenna options connected to the universal server base unit by a coaxial cable.

### BACKGROUND OF THE INVENTION

Wireless repeaters, which are also referred to as cellular signal enhancers, serve an important function in the cellular telephone industry. They can be implemented as portable “personal repeater” units that receive, amplify and repeat bidirectional wireless telephone signals between cellular base stations and wireless telephones located in a structure, typically a home or office, where low signal strength from the base station causes degraded service or, in some cases, no service at all. In addition, low signal strength causes the wireless telephone to increase its transmission power, which drains the battery more quickly. This makes the wireless repeater an important, if not indispensable, piece of equipment for a wide range of customers, including the increasing number of customers who rely on wireless telephone service exclusively and, therefore, do not have a land line alternative available in their homes or businesses. Sufficiently reliable wireless telephone service is also especially important for those who rely on wireless telephone service for data communications, such as Internet access, credit card transactions, intranet communications with a remote office location, and the like.

Because a portable wireless repeater is designed to be installed in homes and businesses (for this reason the personal repeater is sometimes referred to as “customer premises equipment” or CPE), it is also desirable for the units to be as inconspicuous and aesthetically pleasing as possible. One approach described in U.S. Ser. Nos. 10/375,879; 11/127,668 and 11/372,856 locates the server and donor antennas within a single enclosure, which also reduces the cost and weight in most instances and generally eases installation. Making the unit wireless repeater small and deployed in a single housing, however, brings the server and donor antennas into close proximity. This generally increases the tendency of the repeater to develop positive feedback instability, thereby limiting the gain that can be effectively applied by the unit. Innovations that help to alleviate positive feedback instability by improving server-donor antenna feedback suppression are therefore desirable to permit reduced size of the unit, increased gain, and improved signal quality. Accordingly, there is an ongoing need for techniques that improve the server-donor antenna feedback suppression in a wireless repeater. This capability should be implemented in a cost effective, reliable, flexible and sturdy manner to the extent possible.

In addition, flexibility is also desirable for products intended to be installed in a wide range of customer premises having different installation concerns and signal strength considerations. On one hand, standardization is desirable to minimize the part count required to support a product line, and on the other hand, flexibility is desirable to allow users to select among available options to meet their individual needs and preferences. This is a particularly relevant tradeoff when designing a product line intended for wide spread installation in homes and businesses, where customer preference, installation requirement and signal strength conditions are expected to vary widely. Accordingly, there is an ongoing need for cost effective wireless repeater configurations that provide customers with desirable choices.

### SUMMARY OF THE INVENTION

The present invention meets the needs described above in a wireless repeater that includes a universal server base unit that accepts a variety of modular donor antenna options including an internal donor antenna board and an internal adapter module that typically includes a cable port for receiving a coaxial cable connected to an external donor antenna option. This allows the same universal server base unit to work with a variety of internal and external donor antenna options. The server base unit preferably includes a dual polarization server antenna using different polarizations for the uplink and downlink signal paths and a diplexer that enables duplex communication of the downlink and uplink signal paths over a single coaxial cable to an external donor antenna. The external donor antenna options include outdoor swivel-mounted options including a helical circular polarization antenna, a dual polarization panel antenna, and a vertical polarization panel antenna. The external dual polarization antenna option uses different polarizations for the uplink and downlink signal paths and also includes a diplexer to enable duplex communications with the server base unit over the single coaxial cable connection. The external donor antenna options may also include an optional donor bidirectional amplifier that is powered via the cable from the server base unit.

Generally described, the invention may be implemented as a wireless repeater that includes a server base unit having a dual polarization server antenna having a downlink portion and an uplink portion located within a portable housing. The repeater also includes a dual polarization donor antenna located outside the housing having a downlink portion and an uplink portion and a communication link operatively connecting the donor antenna and the server base unit. The server base unit also includes a bidirectional amplifier, mounted within the housing, connecting the donor and server downlink portions in a downlink signal path, and also connecting the donor and server uplink portions in an uplink signal path. A base unit diplexer located at the base unit and a donor diplexer located at the donor antenna enable duplex communication of the downlink and uplink signal paths over the communication link. It should be appreciated that this embodiment implements dual cross-polarization isolation, in which wherein the donor downlink and uplink portions have different polarization states, the server downlink and uplink portions have different polarization states, the donor and server downlink portions have different polarization states, and the donor and server uplink portions have different polarization states. In other words, the wireless repeater implements cross polarization both along and between the uplink and downlink signal paths to help avoid positive server-donor feedback oscillations.

In an alternative configuration, the wireless repeater includes a circular polarization donor antenna located outside the housing and a communication link operatively connecting the donor antenna and the server base unit. In another alternative configuration, the circular polarization antenna is replaced by a linear single polarization donor antenna, which may be, for example, a vertical, horizontal or 45 degree slant polarization antenna. For any of these embodiments, the server may be a two-element array of dual polarization microstrip patch antenna elements in which the downlink circuit includes balanced, horizontal polarization antenna feeds and the uplink circuit includes quasi-balanced, vertical polarization antenna feeds. In addition, the wireless repeater may include a pedestal for pivotally mounting the server base unit in a first location of a structure and a swivel mount for mounting the donor antenna in a second location of the structure, to allow the server base unit and the donor antenna to be separately pointed in desired directions.

The specific techniques and structures for implementing this invention will become apparent from the following detailed description of the embodiments and the appended drawings and claims.

### BRIEF DESCRIPTION OF THE DRAWINGS

FIG. 1A is a conceptual block diagram of a wireless repeater with a universal server base unit and an external, outdoor circular polarization antenna.

FIG. 1B is a conceptual block diagram of a wireless repeater with a universal server base unit and an external, outdoor dual polarization panel antenna.

FIG. 2A is a conceptual illustration showing a typical operating environment for a wireless repeater with a universal server base unit and an external, outdoor circular polarization antenna.

FIG. 2B is a conceptual illustration showing a typical operating environment for a wireless repeater with a universal server base unit and an external, outdoor dual polarization panel antenna.

FIG. 3 is a conceptual block diagram of a wireless repeater with a universal server base unit illustrating a variety of modular donor antenna options.

FIG. 4 is a perspective view of a particular embodiment of a wireless repeater with a universal server base unit and a circular polarization donor antenna option.

FIG. 5 is a perspective view of the circular polarization donor antenna option.

FIG. 6 is a perspective exploded view of the circular polarization donor antenna option.

FIG. 7 is a perspective view of a particular embodiment of a wireless repeater with a universal server base unit and a donor panel antenna option.

FIG. 8A is a perspective front view of the donor panel antenna option.

FIG. 8B is a perspective rear view of the donor panel antenna option.

FIG. 9 is a perspective view of the universal server base unit with the donor radome removed to show an internal donor antenna option.

FIG. 10 is a perspective view of the universal server base unit with the internal donor antenna removed as a module.

FIG. 11 is a perspective view of the universal server base unit with an exploded view of am adapter module used to connect an external donor antenna to the base unit.

FIG. 12 is a perspective view of the universal server base unit with the adapter module installed.

FIG. 13 is a perspective exploded view of a dual polarization donor panel antenna suitable for use with the universal server base unit.

FIG. 14 is a perspective exploded view of a vertical polarization donor panel antenna suitable for use with the universal server base unit.

FIG. 15 is a perspective exploded view of the universal server base unit showing the server antenna.

FIG. 16 is a circuit diagram for a feed circuit for a two-element dual polarization server antenna including balanced, horizontal polarization downlink feeds and quasi-balanced, vertical polarization uplink feeds.

FIG. 17 is a circuit diagram for a feed circuit for a four-element dual polarization donor antenna including balanced, vertical polarization downlink feeds and quasi-balanced, horizontal polarization uplink feeds.

### DETAILED DESCRIPTION

The present invention may be implemented as an improvement to the wireless repeater described in commonly-owned copending U.S. patent application Ser. No. 11/372,856 entitled “Dual Polarization Wireless Repeater Including Antenna Elements with Balanced and Quasi-Balanced Feeds” filed Mar. 11, 2006, which describes a number of improvements over a “first generation” wireless repeater described in commonly-owned copending U.S. patent application Ser. No. 10/375,879 entitled “Cellular Signal Enhancer” filed Feb. 26, 2003. The server base unit described in the present application may be basically the same as any of the wireless repeater units described in these prior applications, except that they have been modified to accept a variety of donor antenna options including internal donor antenna options and external donor antenna options connected to the base unit by a communication link, such as a coaxial cable. Therefore, it should be understood that any of the features described in the prior applications can be implemented in the embodiments of the present invention including, for example, frequency band selection, remotely reconfigurable parameters and controllable settings, mechanical antenna isolation techniques, balance and quasi-balanced antenna feeds, dual cross-polarization isolation, and the handy base unit mounting pedestals described in U.S. patent application Ser. No. 11/127,668.

For any of these configurations, an improvement of the present invention lies in a universal server base unit that accepts a variety of modular donor antenna options. Accordingly, the universal server base unit includes a base unit bidirectional amplifier, a server antenna, and a housing that accepts an internal donor antenna board or an internal adapter module that includes a communication interface, such as a cable port for receiving a coaxial cable connected to an external donor antenna. This allows the same universal server base unit to work with a variety of internal and external donor antenna options. In particular, the external donor antennas include outdoor swivel-mounted options including a helical circular polarization antenna, a dual polarization panel antenna, and a linear, single polarization panel antenna such as a vertical, horizontal or 45 degree slant polarization antenna. The donor antenna may also include an optional donor bidirectional amplifier that is powered via the cable from the server base unit.

In one embodiment, the donor antenna is a dual polarization antenna using different polarizations for the uplink and downlink signal paths. In this case, the donor antenna includes a diplexer enabling the uplink and downlink communication to be carried on a single coaxial cable. This embodiment thus implements dual cross-polarization isolation including cross polarization both along and between the uplink and downlink signal paths using an external donor antenna and a single cable connecting the donor antenna to the server base unit. However, it should be appreciated that many different types of donor antenna options can be used with the universal server base unit, and the particular options described below are merely illustrative of the options available.

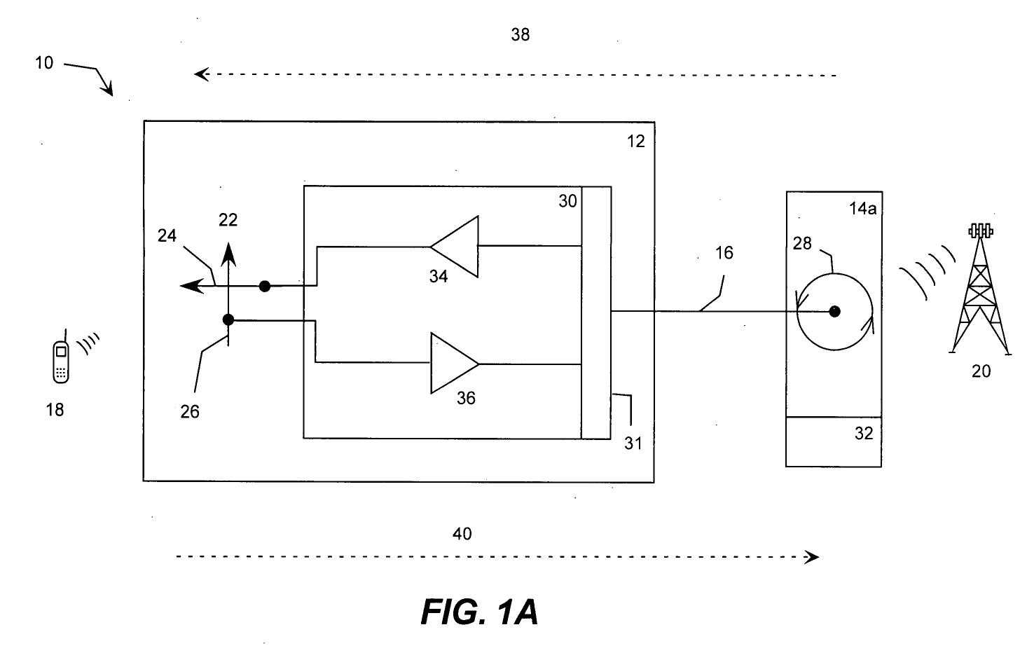

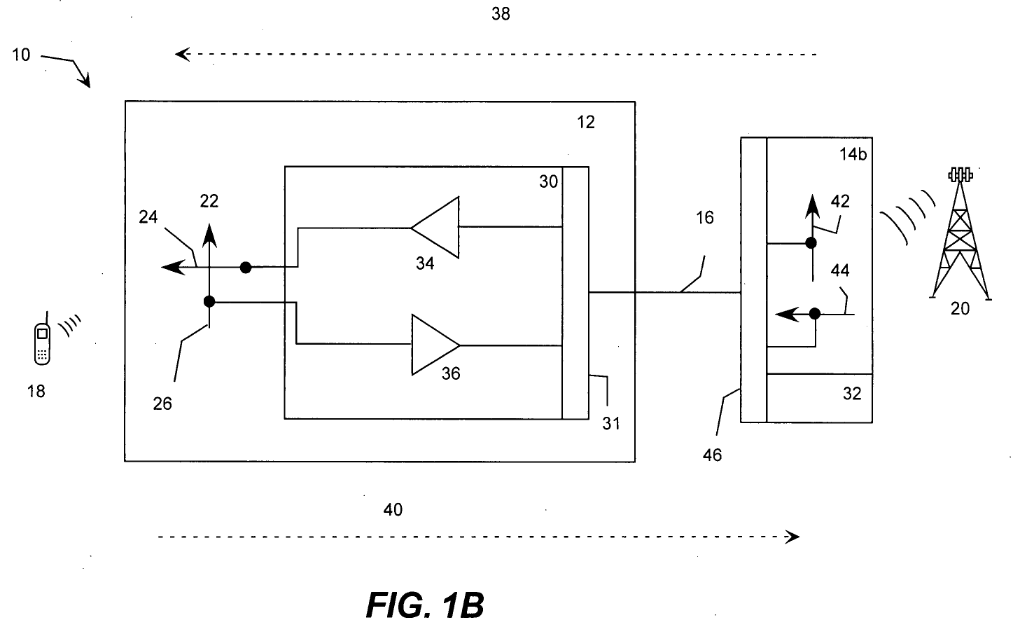

Turning now to the drawings, in which like numerals refer to like elements throughout the several figures, FIG. 1A is a conceptual block diagram of a wireless repeater 10 with a universal server base unit 12 and circular polarization antenna 14a connected to the server base unit by a coaxial cable 16. The universal server base unit 12, which is configured to work with a number of different donor antenna options, includes a server antenna 22 that is designed to communicate with a customer's wireless communication device 18, also is called a mobile unit. Therefore, when the repeater is installed on a wall or in a window, it should be positioned with the server antenna 22 facing into the structure. The antenna donor 14a is configured to communicate with a base station 20 operated by a wireless telephone service provider, also called a “carrier.” In this embodiment, the donor antenna 14a is housed in a separate enclosure from the universal server base unit 12 so that the server antenna can be oriented towards the wireless communication device 18, while the donor antenna can be separately positioned to form good signal path with the base station 20 that is often operating under non-line of sight conditions.

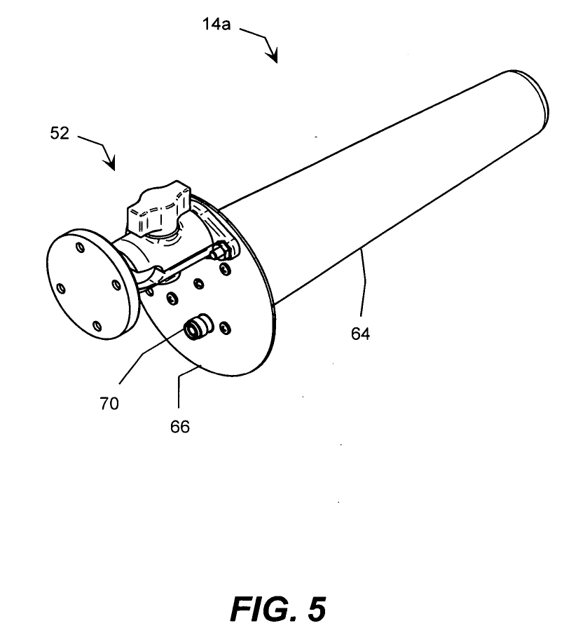

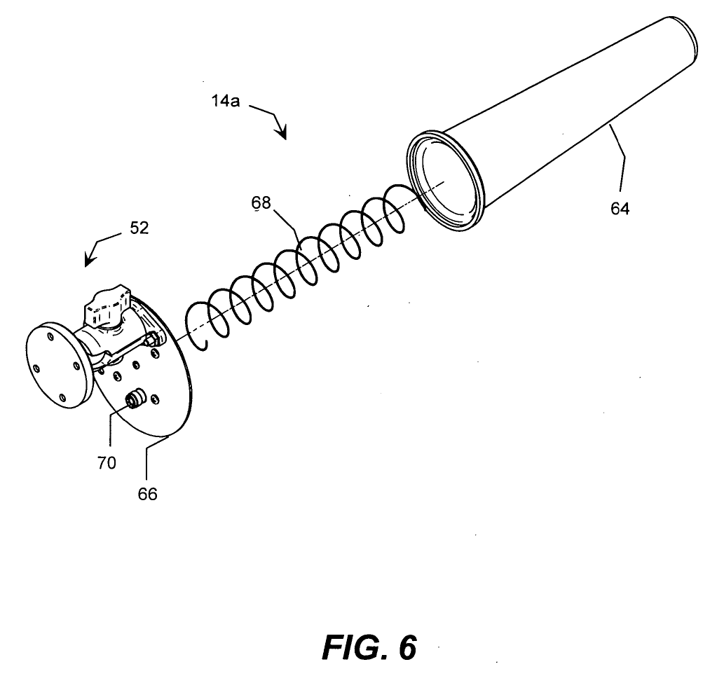

In the universal server base unit 12, the preferred server antenna 22 is a dual-polarization antenna that includes a downlink portion 24 having a first polarization and an uplink portion 26 having a second polarization that is different than the first polarization. In the particular embodiment shown in FIG. 1A, these polarizations are indicate by arrows showing that the downlink portion 24 has a horizontal polarization and the uplink portion 26 has a vertical polarization. However, it will be appreciated that these polarizations could be switched, and that other polarizations, such as 45 degree slant polarizations, could be used. Also, the donor antenna 14a includes a circular polarization antenna element 28, such as a helical antenna element, as shown in more detail in FIGS. 5-6. The use of a dual polarization server antenna 22 and a circular polarization donor antenna 14a helps to prevent server-donor feedback, and represents a type of server-donor polarization isolation that has not previously been incorporated into a wireless repeater. Housing the circular polarization donor antenna 14a external to the server base unit 12 is another aspect of this embodiment that has not been previously incorporated into a wireless repeater.

In addition to the server antenna 22, the universal server base unit 12 also includes a bidirectional amplifier (BDA) 30 that transmits and amplifies the communication signals between the server and donor antennas. This BDA implements the wide range of remotely controllable and reconfigurable functionality as described in U.S. Ser. No. 11/372,856. The base unit also includes a donor antenna board that can be swapped out for an adapter module that includes a communication link, preferably a coaxial cable receptacle, for connecting an external donor antenna to the universal server base unit 12. Because the server antenna is a dual polarization antenna that uses different polarizations for the uplink and downlink signal paths, the adapter module 31 includes a diplexer that allows a single coaxial cable 16 to carry both the uplink and the downlink communication signals between the server base unit 12 and the external donor antenna 14a.

More specifically, the BDA includes a downlink amplifier circuit 34 that receives communication signals from the donor antenna via the cable 16 and the adapter module 31, amplifies theses signals and delivers them to the downlink portion 24 of the server antenna. Similarly, the BDA 12 includes an uplink amplifier circuit 36 that receives communication signals from the uplink portion 26 of the server antenna, amplifies theses signals and delivers them to the donor antenna 14a by way of the cable 16 and the adapter module 31. Thus, the downlink signal path 38 refers to the communication path from the carrier's base station 20 to the customer's mobile unit 18, whereas the uplink signal path 40 refers to the communication path from the mobile unit to the base station. The donor antenna may also include a local donor BDA 32, which is preferably powered by the base unit 12 through the cable 16. It should be noted that the BDA 30 in the base unit 12 is preferably configured to implement an intermediate frequency (IF) used for frequency channel selection (as described in U.S. Ser. No. 11/372,856), while the local donor BDA 32 may be a more traditional RF frequency BDA (as described in U.S. Ser. No. 10/375,879). In addition, the local donor BDA 32 may be built into the same enclosure with the donor antenna, or it may be housed separately as an auxiliary component.

A distinguishing feature of the present invention is the use of a universal server base unit 12 that can accept a number of different donor antenna options. In particular, a variety of different modular donor antenna boards may be selectively installed inside the base unit to construct different versions of the back-to-back wireless repeater described in U.S. Ser. No. 11/372,856. Also, the internal donor antenna module may be replaced by the adapter module 31 shown in FIG. 1A to allow a variety of different external donor antenna options to be connected to the base unit. The circular polarization antenna 14a shown in FIG. 1A is one such option, and the dual polarization antenna 14b shown in FIG. 1B is another available option. This configuration is the same as that shown in FIG. 1A, except for the different external donor option 14b, which in this embodiment is a dual polarization antenna including a downlink portion 42 having vertical polarization and an uplink portion 44 having horizontal polarization. In addition, the downlink portion 42 of the donor has preferably has a different polarization from the downlink portion 24 of the server antenna, and the uplink portion 44 of the donor preferably has a different polarization from the uplink portion 26 of the server antenna. The dual polarization donor antenna 14b also includes a donor diplexer 46 that enables the uplink and downlink signal paths using different polarizations to be carried on a single coaxial cable 16. This configuration, which implements cross-polarization both within and across the uplink and downlink signals paths, is referred to as dual cross-polarization isolation. This server-donor isolation technique was first described in U.S. Ser. No. 10/375,879 and was further developed through the use of balanced and quasi-balanced antenna feeds in U.S. Ser. No. 11/127,668. The present application takes this technique one step further by placing the dual-polarization donor antenna in a separate housing and using diplexers on the server and donor sides to connect both signals paths with a single coaxial cable.

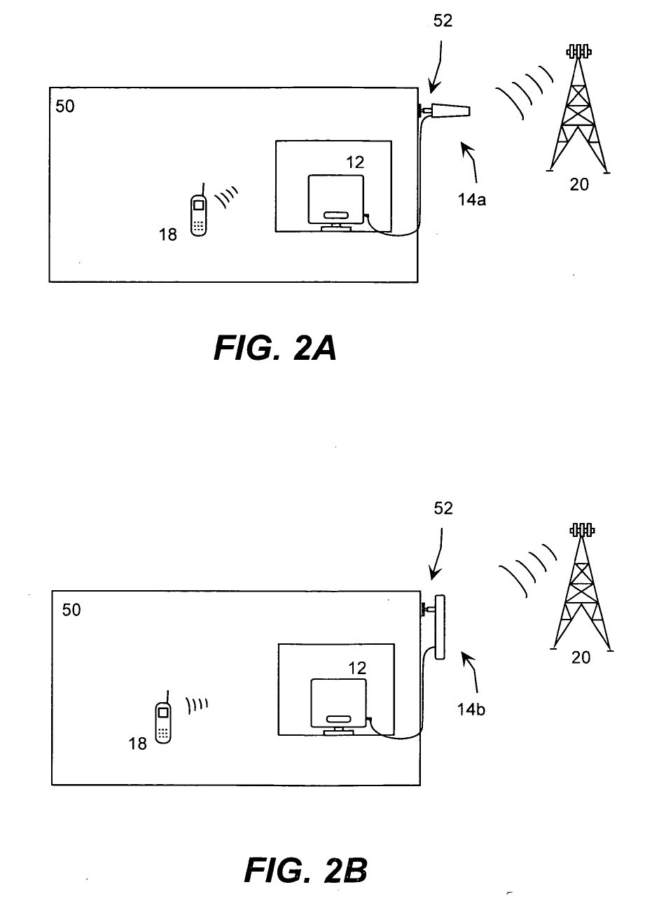

FIG. 2A is a conceptual illustration showing a typical operating environment for the wireless repeater 10 with a universal server base unit 12 and an external, outdoor circular polarization antenna 14a as the donor antenna option. That is, the universal server base unit 12 it typically located on the inside of a structure 50 and oriented towards the mobile unit 18. For example, the mounting pedestal described in U.S. Ser. No. 11/127,668 may be used to mount and point the base unit as desired. The donor antenna 14a, on the other hand, is preferably mounted on the outside of the structure and positioned for good signal communication with the base station 20. A swivel mount 52, such as the one shown in FIGS. 5, may be used to mount and point the donor antenna as desired. The ability to separately mount and point the server base unit 12 and the donor antenna 14a is helpful for maintaining strong signal paths with both the donor and server antennas. FIG. 2B is a conceptual illustration showing the same configuration, except that the donor antenna 14a has been replaced with a panel donor antenna 14b. Preferably, the panel antenna can be attached directly to a wall or the same swivel mount 52 can be used to mount both of these donor antenna options. Of course, other types of donor antenna options may be employed in this modular donor antenna system, some or all of which may be mounted with the same swivel mount 52.

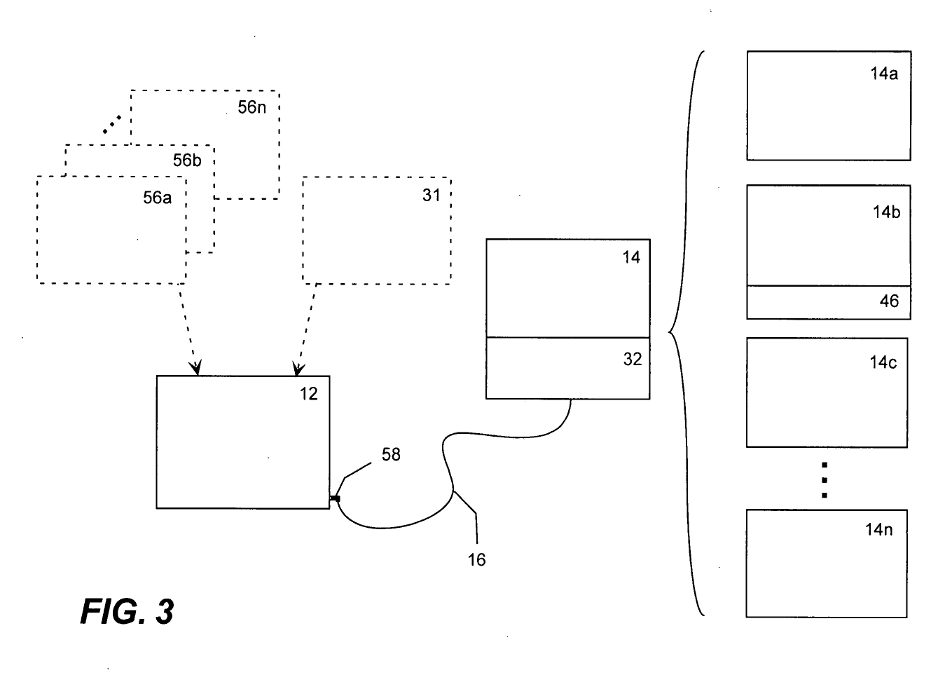

FIG. 3 is a conceptual block diagram of a wireless repeater with a universal server base unit 12 illustrating a variety of modular donor antenna options. Specifically, the present invention provides the ability of the same universal server unit 12 to work with a number of different internal donor antenna options 56a-n that are each deployed on a modular donor board that can be removed and replaced as desired. Several alternative configurations for the internal donor board are described in U.S. Ser. No. 11/372,856. This prior application describes several configurations for a four-element dual polarization panel antenna with balanced and quasi-balanced antenna feed arrangements. Of course, other types of donor antennas can be used, such as a vertical, horizontal, or 45 degree slant single linear polarization antennas or any other suitable antenna configuration. It should be noted that a microstrip panel patch-element array is often preferred to keep the universal server unit 12 thin, but other types of antennas could be used.

In order to accept external donor antenna options, the internal donor antenna board can be removed and replaced by an adapter module 31, which includes a small microstrip diplexer unit deployed PC board and a length of coaxial cable that extends to a coaxial cable port 58 located at an edge of the universal server unit. The adapter module 31 allows a variety of different external donor antenna modules 14a-n to be connected to the universal server unit 12. Specifically, the diplexer operates as a dual bandpass filter that imparts sufficient frequency isolation between the uplink and downlink communication channels to allow both channels to be carried on a single coaxial cable 16. External donor antenna options can include but need not be limited to flat panel antenna options. For example, the available external donor antenna options can include a circular polarization helical antenna 14a, a dual polarization microstrip patch panel antenna 14b, a vertical polarization microstrip patch panel antenna 14c, or any other type of suitable donor antenna configuration. The dual polarization donor antenna module 14b preferably includes a diplexer 46 so that a single coaxial cable 16 can be used to connect the donor antenna to the universal server unit 12. Any of these options may, but need not, include a local donor BDA 32 that receives its power from the universal server unit 12 via the cable 16. Of course, the BDA 32 could be powered separately, for example by a power cord extending to power outlet.

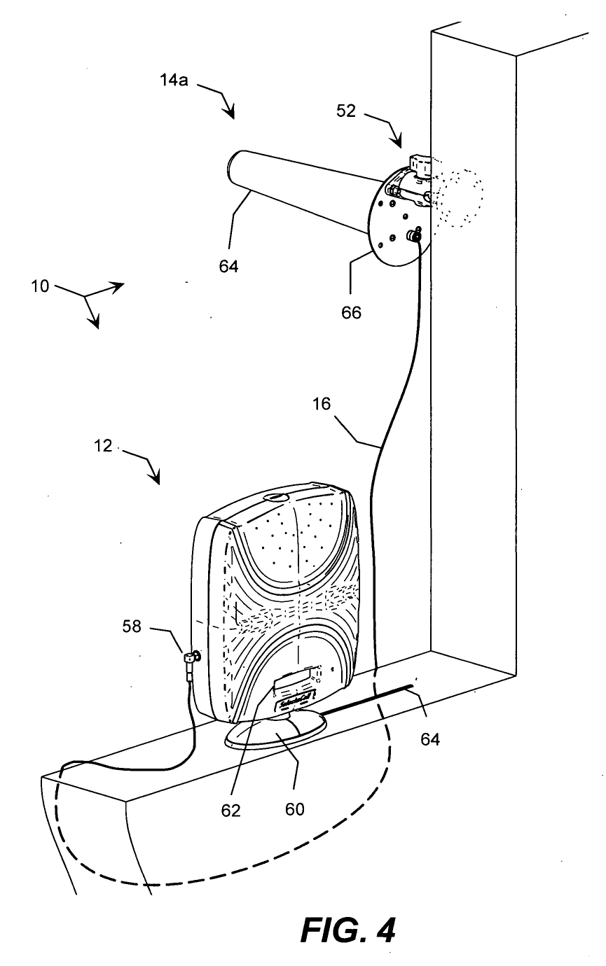

FIGS. 4-15 show perspective views, in some cases assembled and in other cases exploded views, of particular embodiments of the wireless repeater shown substantially to scale. The maximum horizontal dimension of the universal server unit 12 is approximately equal to 8.4 inches [21.3 cm] and the other components are show with their approximate comparative size when shown in the same figure with the universal server unit. FIG. 4A shows a wireless repeater 10 that includes a universal server base unit 12 and a donor antenna option 14a connected to the base unit by a coaxial cable 16. The universal server base unit 12 is supported by a pedestal 60 and shown mounted on a window sill. However, the base unit can be located in any convenient location on the interior of the structure that provides a good communication path between the on-board server antenna and the mobile units to be served by the unit. For example, in many case it may be convenient to hang the unit from the ceiling or locate the unit above ceiling tiles. Some customers may prefer to locate the unit in a closet or behind a piece of furniture for aesthetic reasons. The handy pedestal 60, which is described in U.S. Ser. No. 11/127,668, allows the unit to be mounted from above or from below with the display 62 upright. The base unit also includes a power cable (shown in part) for connecting the unit to a conventional premises power outlet, such as a 120 volt AC power outlet in the U.S. Separating the donor antenna 14a from the universal server base unit 12 makes it easier to locate and point the base unit and the donor antenna in an advantageous positions.

The donor antenna 14a is also shown in FIGS. 5 and 6. This particular donor antenna option is configured to be mounted to the exterior of the structure by a swivel mount 52, which can be used to securely mount some or all of the external donor antenna options to most structures. This particular swivel mount is an off-the-shelf item manufactured by RAM® Mounting Systems. The swivel mount 52 allows the donor antenna to be pointed in whichever direction gives best the signal strength, usually directly at the base station providing service. However, it will be appreciated that the preferred signal direction may not be directly towards the base station in non-line of sight propagation conditions, and the swivel mount 52 allows the customer to easily experiment with different pointing directions. This particular donor antenna 14a includes a radome 64 that is supported by a base platform 66, which has posts for attachment to the swivel mount 52. As shown in FIG. 6, a helical antenna element 68 is located inside the radome 64 and supported by the base platform 66. The swivel mount 52 provides sufficient clearance behind the base platform 66 to attach the coaxial cable 16 to the cable port 70 located on the rear of the base platform.

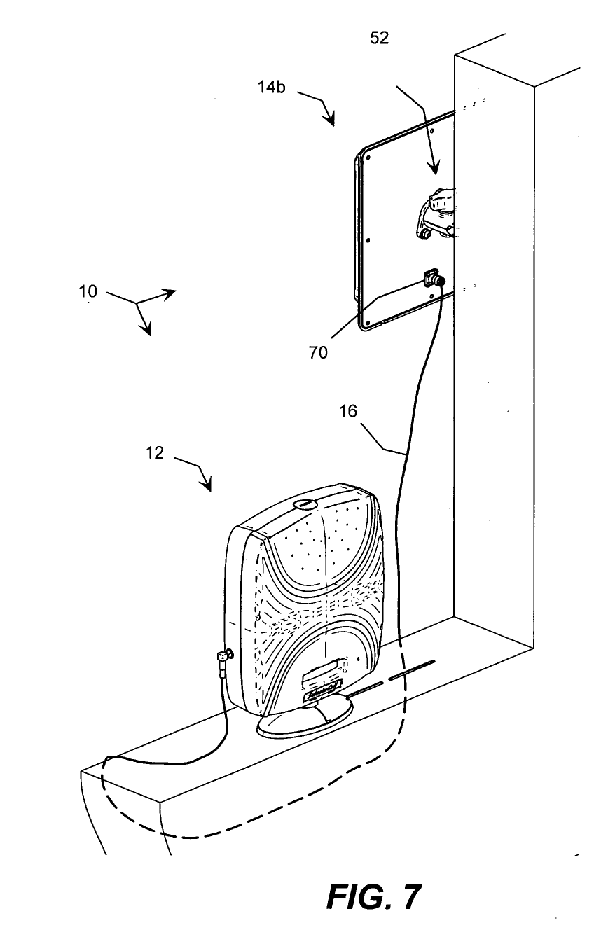

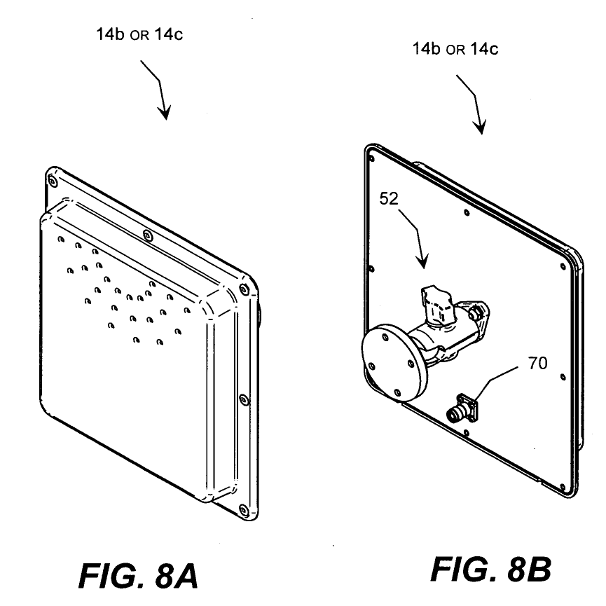

FIG. 7 shows the same wireless repeater unit as FIG. 4, except that the donor antenna 14a shown in FIG. 4 has been replaced by a donor panel antenna 14b. FIG. 8A show the front and FIG. 8B shows the rear of the panel antenna. The same swivel mount 52 can be used with this donor antenna option.

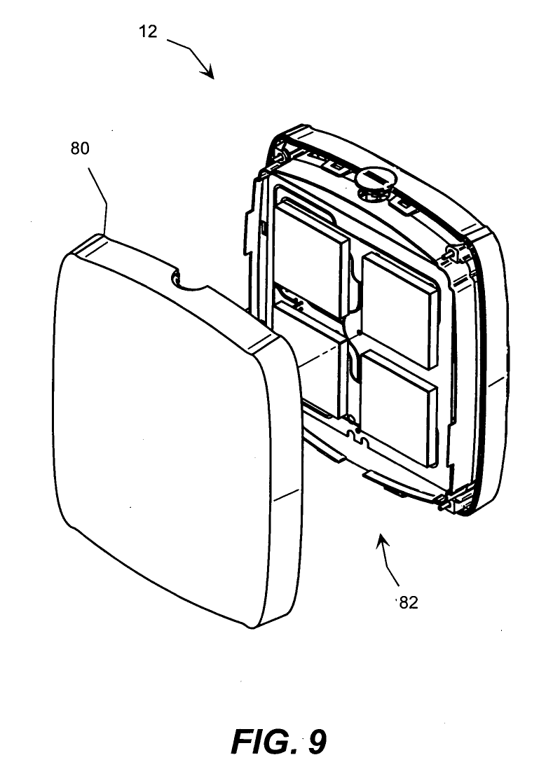

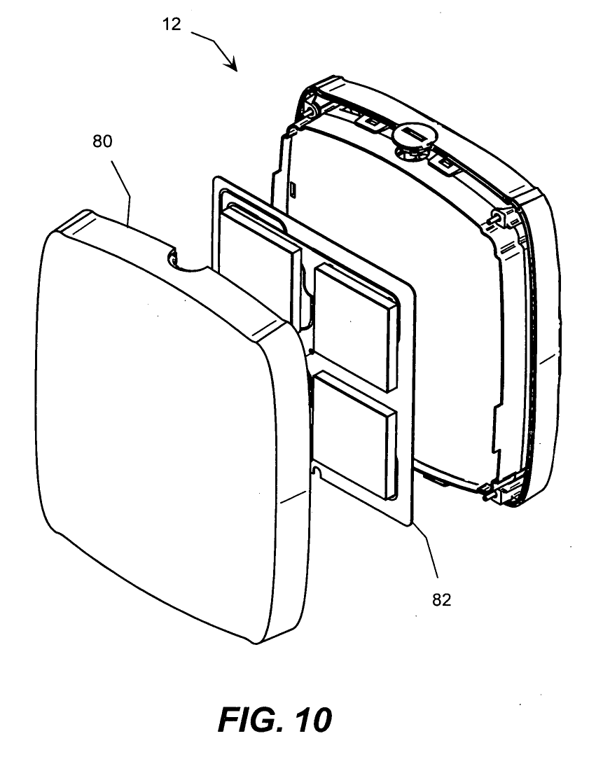

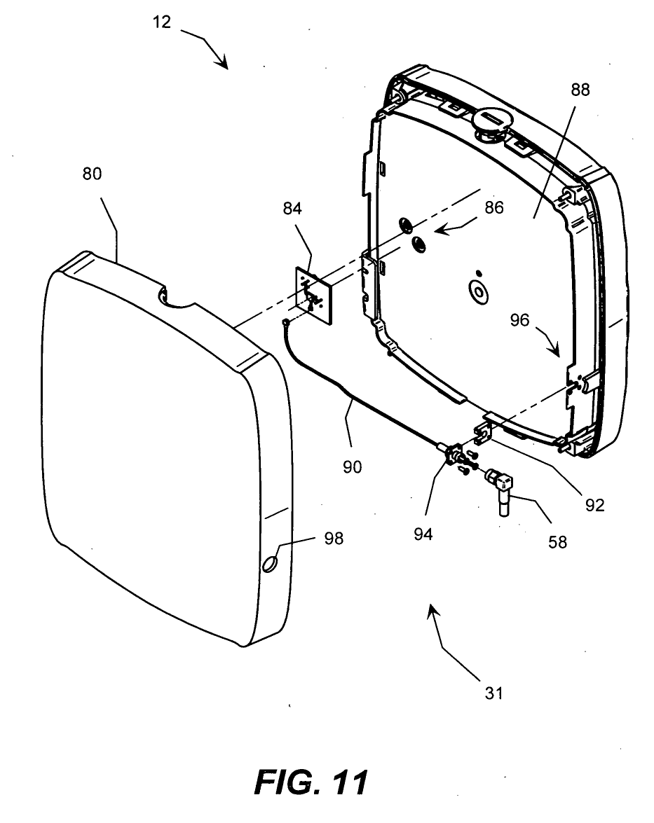

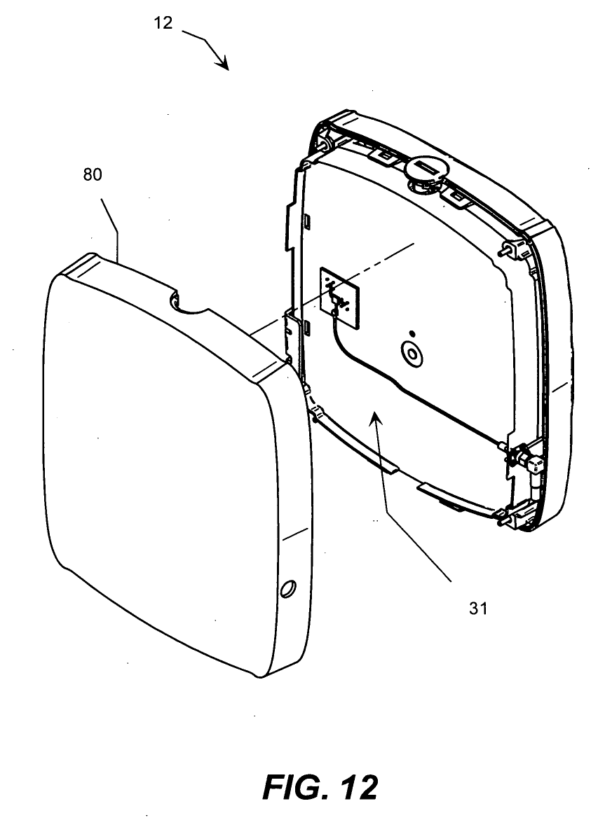

FIG. 9 shows the universal server base unit 12 with the donor radome 80 removed. This particular embodiment includes an internal four-patch donor antenna module 82, as described in U.S. Ser. No. 11/372,856. The internal donor antenna module 82 can be easily removed, as shown in FIG. 10, and replaced with the adapter module 31, as shown in FIG. 11. The adapter module 31 includes a small microstrip diplexer board 84 that plugs directly into the same RF port 86 that accepts the donor antenna module 82. The RF port extends through the donor mounting plate 88 and connects to the BDA circuit board, which is mounted to the opposing side of the donor mounting plate. The diplexer board 84 is connected to the cable port 58 by a short length of coaxial cable 90. A clip 92 secures a cable connector 94 at the end of the cable 90 to a small mounting flange 96 formed in the side wall of the donor mounting plate 88. The cable port 58 extends from the connector 94 through a hole 98 in the side of the donor radome 80. FIG. 12 shows an assembled view of the adapter module 31.

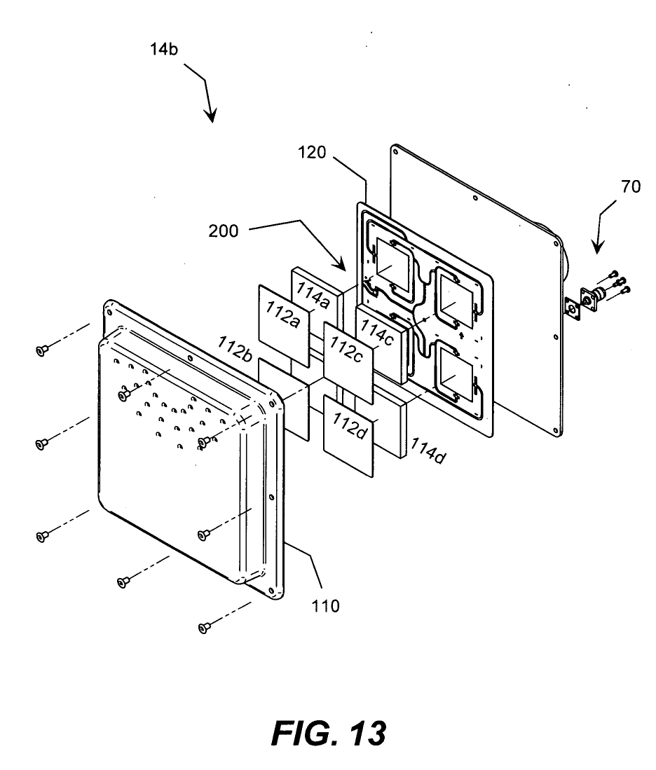

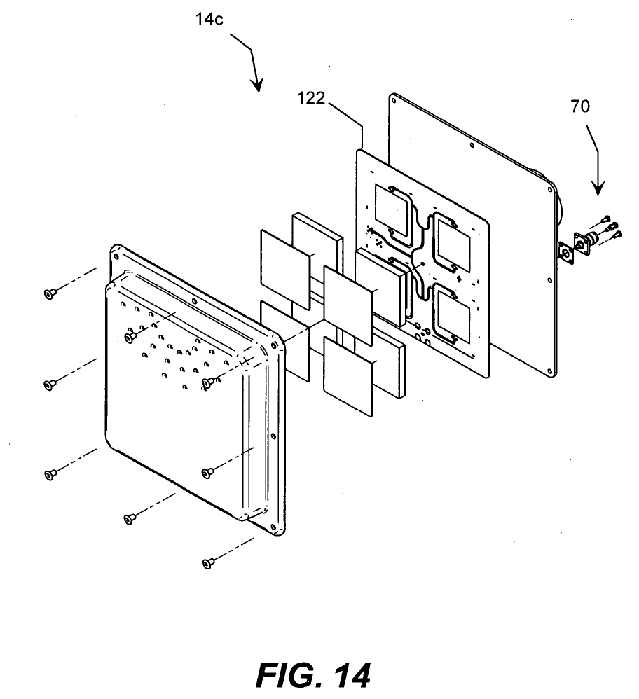

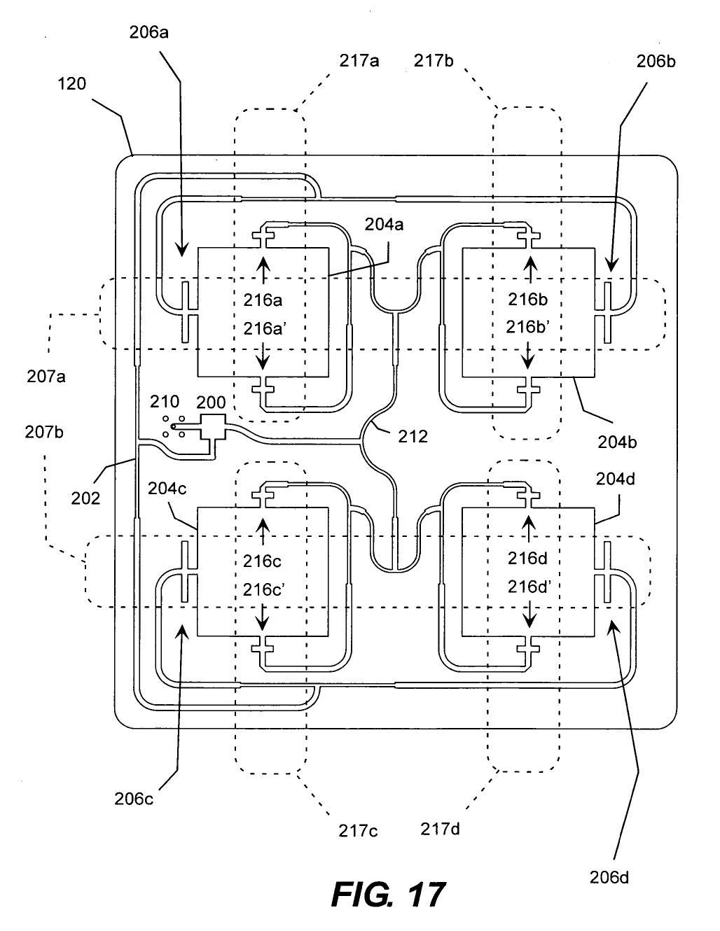

FIG. 13 shows an exploded view of the donor panel antenna option 14b. This antenna includes a donor antenna feed circuit board 120 implementing a four-element microstrip patch antenna array very similar to the donor antenna described in U.S. Ser. No. 11/372,856 except that this unit includes a diplexer (see the diplexer 200 shown in FIG. 17) that connects to the cable connector 70. This particular donor antenna is a dual polarization antenna with balanced, vertical polarization antenna feeds for the downlink channel and quasi-balanced, horizontal antenna feeds for the uplink channel. From left to right in FIG. 13, the donor antenna 14b includes a donor radome 110, a set of four parasitic radiating antenna elements 112a-d, a set of four foam dielectric spacers 14a-d, and a donor microstrip antenna board 120 that carries a microstrip feed circuit, the diplexer 200, and four dual-polarization patch antenna elements 116a-n. This particular antenna feed circuit board 120 is shown in greater detail in FIG. 17. In addition, FIG. 14 shows an alternative donor antenna option 14c that is similar except that it includes a donor antenna feed circuit board 122 that implements a set of four single, vertical polarization patch antenna elements. As this is a single polarization option, a diplexer is not required for the donor antenna.

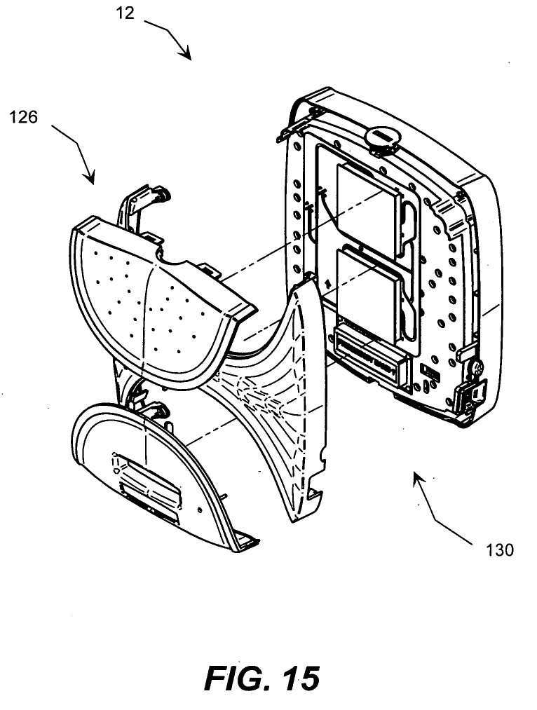

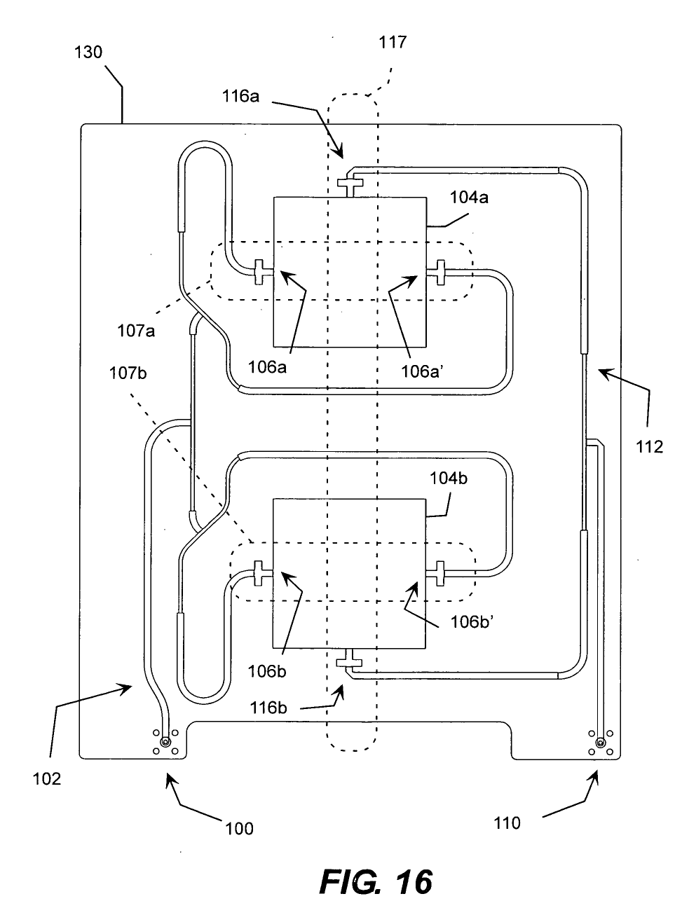

FIG. 15 is a perspective exploded view of the universal server base unit 12 with the server radome 126 removed to reveal the server antenna board 130, which is shown in greater detail in FIG. 16. The server antenna includes two dual polarization microstrip patch antenna elements that are similar to the donor patch antenna elements described with reference to FIG. 13. That is, each antenna element included a parasitic radiating element supported by a dielectric foam spacer, which in turn is attached on top of a microstrip patch element on the server antenna board 130.

Referring to FIG. 16, in this particular embodiment the server antenna is a two-element array of dual-polarization, microstrip patch antenna elements 104a and 104b in which both antenna elements include uplink and downlink portions. For the server downlink circuit, the server antenna feed circuit includes a server downlink port 100, which connects to a server downlink circuit trace 102. The server downlink circuit trace 102, in turn, connects to an upper server patch antenna element 104a at two horizontally oriented, opposing element feeds 106a and 106a′. The downlink feed trace 102 also connects to a lower server patch antenna element 104b at two horizontally oriented, opposing element feeds 106b and 106b′. For the server uplink circuit, the server antenna feed circuit includes a server uplink port 110, which connects to a server uplink circuit trace 112. The server uplink circuit trace 112, in turn, connects to the upper server patch antenna element 104a at a single, vertically-oriented, downward facing element feed 116a. The uplink server feed trace 112 also connects to the lower server patch antenna element 104b at a single, vertically-oriented, upward facing element feed 116b.

In this particular antenna, the two horizontally oriented, opposing element feeds 106a and 106a′ form a balanced, horizontal polarization feed arrangement 107a for the upper server antenna element 104a. In addition, the single vertically-oriented, downward facing element feed 116a forms an unbalanced, vertical polarization feed arrangement for the upper server antenna element 104a. Thus, the upper server antenna element 104a is a dual-polarization antenna element that includes a combination of a balanced and unbalanced antenna feed arrangements. Specifically, the downlink portion of the antenna element 104a includes a balanced, horizontal polarization feed arrangement implemented by the horizontally oriented, opposing element feeds 106ab and 106a′. In addition, the uplink portion of the antenna element 104a includes an unbalanced, vertical polarization feed arrangement implemented by the antenna feed 116a. The same can be said for the lower server antenna element 104b. That is, the downlink portion of the lower server antenna element 104b includes a balanced, horizontal polarization feed arrangement 107b implemented by the horizontally oriented, opposing element feeds 106b and 106b′. And the uplink portion of the lower server antenna element 104b includes an unbalanced, vertical polarization feed arrangement implemented by the antenna feed 116b. In addition, the unbalanced feeds 116a and 116b form a two-element, quasi-balanced antenna feed configuration 117. Alternatively, the server antenna could include balanced feeds for both the uplink and downlink circuits. However, this dual-balanced configuration requires crossovers in the feed circuit, as described in U.S. Ser. No. 11/372,856.

FIG. 17 is a front view of a particular embodiment of an external dual polarization donor antenna feed circuit board 120. Like the server antenna feed circuit shown in FIG. 16, this particular donor antenna feed circuit includes dual-polarization, microstrip patch dual-polarization antenna elements and a combination of balanced and quasi-balanced antenna feed configurations, which allows the feed circuit to be implemented without crossovers. Like the server antenna, the donor antenna could alternatively include balanced feeds for both the uplink and downlink circuits. Again, this dual-balanced configuration requires crossovers in the feed circuit, as described in U.S. Ser. No. 11/372,856.

For the donor uplink circuit, the donor antenna feed circuit 120 includes a diplexer 200, which connects donor uplink circuit trace 202 and a donor downlink circuit trace 212 to an RF port 210 that connects to the cable port 70 shown on FIG. 13. The donor uplink circuit trace 202, in turn, connects to an upper-left donor antenna element 204a at a horizontally oriented element feed 206a. Similarly, the donor uplink circuit trace 202 connects to an upper-right donor antenna element 204b at a horizontally oriented element feed 206b. The donor uplink circuit trace 202 also connects to a lower-left donor antenna element 204c at a horizontally oriented element feed 206c. Similarly, the donor uplink circuit trace 202 connects to a lower-right donor antenna element 204d at a horizontally oriented element feed 206d.

The donor downlink circuit trace 212 connects to the upper-left donor antenna element 204a at two opposing, vertically oriented element feeds 216a and 216a′ forming a balanced, vertically oriented feed arrangement 217a. Similarly, the donor downlink circuit trace 212 connects to the upper-right donor antenna element 204b at two opposing, vertically oriented element feeds 216b and 216b′ forming a balanced, vertically oriented feed arrangement 217b. The donor downlink circuit trace 212 also connects to the lower-left donor antenna element 204c at two opposing, vertically oriented element feeds 216c and 216c′ forming a balanced, vertically oriented feed arrangement 217c. Similarly, the donor downlink circuit trace 212 connects to the lower-right donor antenna element 204d at two opposing, vertically oriented element feeds 216d and 216d′ forming a balanced, vertically oriented feed arrangement 217d.

FIG. 17 therefore shows that the downlink portion of the donor antenna includes a first balanced, vertical polarization antenna feed arrangement 217a implemented by the opposing, vertically oriented antenna feeds 216a and 216a′ for the upper left antenna element 204a. A second balanced, vertical polarization antenna feed arrangement 217b is implemented by the opposing, vertically oriented antenna feeds 216b and 216b′ for the upper right antenna element 204b. A third balanced, vertical polarization antenna feed arrangement 217c is implemented by the opposing, vertically oriented antenna feeds 216c and 216c′ for the lower left antenna element 204c. And a fourth balanced, vertical polarization antenna feed arrangement 217d is implemented by the opposing, vertically oriented antenna feeds and 216d and 216d′ for the lower right antenna element 204d.

In addition, the uplink portion of the donor antenna includes a first unbalanced, horizontal polarization antenna feed arrangement implemented by the horizontally oriented antenna feed 206a for the upper left antenna element 204a. A second unbalanced, horizontal polarization antenna feed arrangement is implemented by the horizontally oriented antenna feed 206b for the upper right antenna element 204b. A third unbalanced, horizontal polarization antenna feed arrangement is implemented by the horizontally oriented antenna feed 206c for the lower left antenna element 204c. And a fourth unbalanced, horizontal polarization antenna feed arrangement is implemented by the horizontally oriented antenna feed 206d for the lower right antenna element 204d. It should also be understood that the upper antenna elements 204a and 204b form a quasi-balanced feed arrangement 207a implemented by the opposing, horizontally oriented antenna feeds 206a and 206b located on two adjacent antenna elements. Similarly, the lower antenna elements 204c and 204d form a quasi-balanced feed arrangement 207b implemented by the opposing, horizontally oriented antenna feeds 206c and 206d located on two adjacent antenna elements.

In view of the foregoing, it will be appreciated that present invention provides significant improvements in wireless repeaters. It should be understood that the foregoing relates only to the exemplary embodiments of the present invention, and that numerous changes may be made therein without departing from the spirit and scope of the invention as defined by the following claims.

The invention claimed is:

1. A wireless repeater comprising:
a server base unit comprising a dual polarization server antenna located within a portable housing, the server antenna having a downlink portion and an uplink portion;
a dual polarization donor antenna located outside the housing having a downlink portion and an uplink portion;
a communication link operatively connecting the donor antenna and the server base unit;
a bidirectional amplifier, mounted within the housing, connecting the donor and server downlink portions in a downlink signal path, and also connecting the donor and server uplink portions in an uplink signal path; and
a base unit diplexer located at the base unit and a donor diplexer located at the donor antenna, the diplexers enabling duplex communication of the downlink and uplink signal paths over the communication link;
wherein the donor downlink and uplink portions have different polarization states, the server downlink and uplink portions have different polarization states, the donor and server downlink portions have different polarization states, and the donor and server uplink portions have different polarization states.

2. The wireless repeater of claim 1, wherein the communication link comprises a coaxial cable.

3. The wireless repeater of claim 1, wherein:
the server antenna comprises a two-element array of dual polarization, microstrip patch antenna elements; and
the donor antenna comprises a four-element array of dual polarization, microstrip patch antenna elements.

4. The wireless repeater of claim 2, wherein the donor antenna comprises a donor bidirectional amplifier that is powered via the cable from the server base unit.

5. The wireless repeater of claim 3, wherein:
the server antenna downlink portion comprises balanced, horizontal polarization antenna feeds;
the server antenna uplink portion comprises quasi-balanced, vertical polarization antenna feeds;
the donor antenna downlink portion comprises balanced, vertical polarization antenna feeds; and
the donor antenna uplink portion comprises quasi-balanced, horizontal polarization antenna feeds.

6. The wireless repeater of claim 1, further comprising:
a pedestal for pivotally mounting the server base unit in a first location of a structure;
a swivel mount for mounting the donor antenna in a second location of the structure;
wherein the pedestal and the swivel mount allow the server base unit and the donor antenna to be separately pointed in desired directions.

7. A wireless repeater comprising:
a server base unit comprising a dual polarization server antenna located within a portable housing, the server antenna having a downlink portion having a first polarization state and an uplink portion having a second polarization state;
a circular polarization donor antenna located outside the housing;
a communication link operatively connecting the donor antenna and the server base unit; and
a bidirectional amplifier, mounted within the housing, connecting the server downlink portion and the donor antenna in a downlink signal path, and also connecting the server uplink portion and the donor antenna in an uplink signal path.

8. The wireless repeater of claim 7, wherein the communication link comprises a coaxial cable, further comprising a base unit diplexer enabling duplex communication of the downlink and uplink signal paths over the coaxial cable.

9. The wireless repeater of claim 7, wherein:
the server antenna comprises an array of dual polarization, microstrip patch antenna elements; and
the donor antenna comprises a helical antenna element.

10. The wireless repeater of claim 8, wherein the donor antenna comprises a donor bi-directional amplifier that is powered via the cable from the server base unit.

11. The wireless repeater of claim 10, wherein:
the server antenna downlink portion comprises balanced, horizontal polarization antenna feeds;
the server antenna uplink portion comprises quasi-balanced, vertical polarization antenna feeds.

12. The wireless repeater of claim 7, further comprising:
a pedestal for pivotally mounting the server base unit in a first location of a structure;
a swivel mount for mounting the donor antenna in a second location of the structure;
wherein the pedestal and the swivel mount allow the server base unit and the donor antenna to be separately pointed in desired directions.

13. A wireless repeater comprising:
a server base unit comprising a server antenna located within a portable housing;
the server base unit configured to removably receive a selection of donor antenna modules including an internal donor antenna option and an internal adapter module configured to receive a communication link for operatively connecting an external donor antenna option to the server base unit;
a bidirectional amplifier, mounted within the housing, connecting the server antenna and an installed donor antenna module in a duplex communication signal path;
at least one selectable internal donor antenna option; and
at least one selectable external donor antenna option.

14. The wireless repeater of claim 13, wherein for an external donor antenna option the duplex signal path comprises a downlink signal path from the donor antenna to the server antenna and an uplink signal path from the server antenna to the donor antenna, and wherein:
the server antenna comprises a dual polarization server antenna;
the communication link comprises a coaxial cable; and
the adapter module comprises a base unit diplexer enabling duplex communication of the downlink and uplink signal paths over the coaxial cable.

15. The wireless repeater of claim 14, wherein the external donor antenna option comprises a circular polarization donor antenna.

16. The wireless repeater of claim 14, wherein:
the external donor antenna option comprises a dual polarization donor antenna having an uplink portion and a downlink portion;
the external donor antenna option comprises a donor diplexer enabling duplex communication of the downlink and uplink signal paths over the coaxial cable; and
the donor downlink and uplink portions have different polarization states, the server downlink and uplink portions have different polarization states, the donor and server downlink portions have different polarization states, and the donor and server uplink portions have different polarization states.

17. The wireless repeater of claim 16, wherein:
the server antenna comprises a two-element array of dual polarization, microstrip patch antenna elements; and
the external donor antenna option comprises a four-element array of dual polarization, microstrip patch antenna elements.

18. The wireless repeater of claim 14, further comprising:
a pedestal for pivotally mounting the server base unit in a first location of a structure;
a swivel mount for mounting an external donor antenna option in a second location of the structure;
wherein the pedestal and the swivel mount allow the server base unit and the external donor antenna option antenna to be separately pointed in desired directions.

19. A wireless repeater comprising:
a server base unit comprising a dual polarization server antenna located within a portable housing, the server antenna having a downlink portion having a first polarization state and an uplink portion having a second polarization state;
a linear single polarization donor antenna located outside the housing;
a communication link operatively connecting the donor antenna and the server base unit; and
a bidirectional amplifier, mounted within the housing, connecting the server downlink portion and the donor antenna in a downlink signal path, and also connecting the server uplink portion and the donor antenna in an uplink signal path.

20. The wireless repeater of claim 19, wherein the communication link comprises a coaxial cable, further comprising a base unit diplexer enabling duplex communication of the downlink and uplink signal paths over the coaxial cable.
